(19) United States
(12) Patent Application Publication
(10) Pub. No.: US 2012/0085232 A1
(43) Pub. Date: Apr. 12, 2012

(54) METHODS FOR REMOVING CONTAMINANTS FROM NATURAL GAS

(76) Inventors: Rustam H. Sethna, Clinton, NJ (US); Ramachandran Krishnamurthy, Chestnut Ridge, NY (US)

(21) Appl. No.: 13/084,891

(22) Filed: Apr. 12, 2011

Related U.S. Application Data
(60) Provisional application No. 61/331,970, filed on May 6, 2010.

(51) Int. Cl. B01D 53/047; B01D 53/26

(52) U.S. Cl. 95/41; 95/51

(57) ABSTRACT

A method for removing contaminants from natural gas streams. The natural gas stream is fed to a dryer, then a membrane module and a multibed, multilayer vacuum swing adsorption process for removal of oxygen, nitrogen and carbon dioxide from the natural gas stream. Alternatively when carbon dioxide is in relatively low concentration in the natural gas stream, the membrane module step is not employed.

### CROSS REFERENCE TO RELATED APPLICATIONS

This application claims priority from U.S. provisional patent application Ser. No. 61/331,970 filed May 6, 2010.

### BACKGROUND OF THE INVENTION

The invention relates to a method for removing contaminant gas such as oxygen and nitrogen from natural gas. More particularly the invention provides for a method for the multi-stage removal of contaminant gases such as carbon dioxide, oxygen and nitrogen from natural gas.

Natural gas is known to be extracted from underground reservoirs. The natural gas will often contain nitrogen and oxygen and other gas considered impurities. These unwanted gases could be naturally occurring or the result of a process like nitrogen injection into the reservoir as part of an enhanced oil recovery.

Earlier processes have attempted the removal of these contaminant gases from natural gas. For example, a pressure swing adsorption (PSA) process separates hydrogen from natural gas by two separate PSA stages, the first stage for nitrogen and the second stage for hydrogen. Alternatively a PSA process is employed which utilizes two separate PSA stages. The first stage removes hydrocarbons from the natural gas and the second stage removes nitrogen. In a different approach, methane is recovered from crude natural gas and solid waste landfill exhaust gas by a sequential operation of a PSA step to remove volatile organic compounds. This stream is fed to a membrane system whereby carbon dioxide is removed from the natural gas stream.

These processes, however, do not provide bulk removal of oxygen and nitrogen from natural gas streams, nor do they also remove carbon dioxide, all in amounts necessary to enable the natural gas to be used as a fuel source.

### SUMMARY OF THE INVENTION

The invention provides for a method for removing contaminant gases from a natural gas stream comprising feeding a natural gas stream containing contaminants to a dryer, a membrane module and a vacuum swing adsorption (VSA) system.

More particularly, the invention provides for the removal of contaminants from a natural gas stream comprising the steps:

a) feeding the natural gas stream containing contaminants to a dryer which can be either a pressure swing adsorption (PSA) or temperature swing adsorption (TSA) process;
b) feeding the dry natural gas stream to a membrane module where carbon dioxide and oxygen are removed from the natural gas stream; and
c) feeding natural gas stream to a multibed, multilayer vacuum swing adsorption system wherein carbon dioxide, nitrogen and oxygen are removed from the natural gas stream.

The contaminants that are present in the natural gas are oxygen, nitrogen and carbon dioxide. These gases are primarily present in amounts ranging from 0 to 5 mole % oxygen; 5 to 15 mole % nitrogen and 30 to 45 mole carbon dioxide in the natural gas.

The PSA or TSA process of step a) will remove water from the natural gas stream. Typically an adsorbent material such as activated alumina will be present in the beds of either the PSA or TSA system.

The membrane module of step b) will remove carbon dioxide in bulk. In one embodiment, a single set of membranes is employed and in a different embodiment a second set of membranes is added following the first. This second set of membranes will polish further the amount of carbon dioxide present in the natural gas stream. Certain membranes can be employed such as modified hollow fiber polyamide nitrogen membranes to remove up to half of the oxygen present in the natural gas stream as well. This will reduce the amount of oxygen removal needed in following steps.

In step c), the multibed, multilayer VSA system will typically contain four beds. However, more or less beds can be employed depending upon the amount of contaminants in the natural gas stream and power cost concerns. Each bed is layered for removal of carbon dioxide, nitrogen and oxygen. For the removal of carbon dioxide, a 13× molecular sieve material is used. For the nitrogen removal, a titanosilicate sieve material is employed. A carbon molecular sieve or other material which has a high affinity for oxygen is used as the third layer, and can be determined by how much oxygen is removed by the membrane modules of step b).

In a further embodiment of the invention, when carbon dioxide concentrations are low in the natural gas, the natural gas stream containing contaminants is fed to a temperature swing adsorption system to remove moisture, and then is fed to a multibed, multilayer vacuum swing adsorption system wherein nitrogen and oxygen are removed from the natural gas stream.

In this embodiment similar materials as described for the three step process may be used in the temperature swing adsorption step and the vacuum swing adsorption step.

In a further embodiment of the invention, an oxygen rejection system is disclosed. A natural gas stream containing contaminants is first fed to a membrane module where carbon dioxide is removed; the natural gas stream is then fed to a multibed, multilayer vacuum swing adsorption system where carbon dioxide and nitrogen are removed. The natural gas stream is then directed to a liquefier and then to an oxygen stripper column where the remainder of oxygen present in the natural gas stream is removed from the natural gas, which can be sent to an oxygen storage system for later use.

In this embodiment the natural gas stream is first treated for trace contaminants before being fed to membrane modules. The membrane modules may be a single membrane or two or more membranes in series. The membrane modules will remove carbon dioxide from the natural gas stream and may, depending upon the type of membrane material used, remove oxygen from the natural gas stream as well. The natural gas stream is directed to a multibed VSA system where each bed is multilayered. This multibed, multilayer VSA system will typically contain four beds. However, more or less beds can be employed depending upon the amount of contaminants in the natural gas stream and power cost concerns. Each bed is layered for removal of carbon dioxide, nitrogen and oxygen. For the removal of carbon dioxide, a 13× molecular sieve material is used. For the nitrogen removal, a titanosilicate sieve material is employed. A carbon molecular sieve or other material which has a high affinity for oxygen is used as the third layer, and can be determined by how much oxygen is removed by the membrane modules.

The natural gas stream is then directed to a liquefier before being fed to an oxygen stripper column which can be of the packed or tray type. The remainder of oxygen present in the natural gas is removed here and the natural gas recovered and removed to storage.

### BRIEF DESCRIPTION OF THE DRAWINGS

FIG. 1 is a schematic of a natural gas purification system using a single membrane module.

FIG. 2 is a schematic of a natural gas purification system using two membrane modules.

FIG. 3 is a schematic of a natural gas purification system where there are no membrane modules.

FIG. 4 is a schematic of an oxygen rejection system for a liquid natural gas production system.

### DETAILED DESCRIPTION OF THE INVENTION

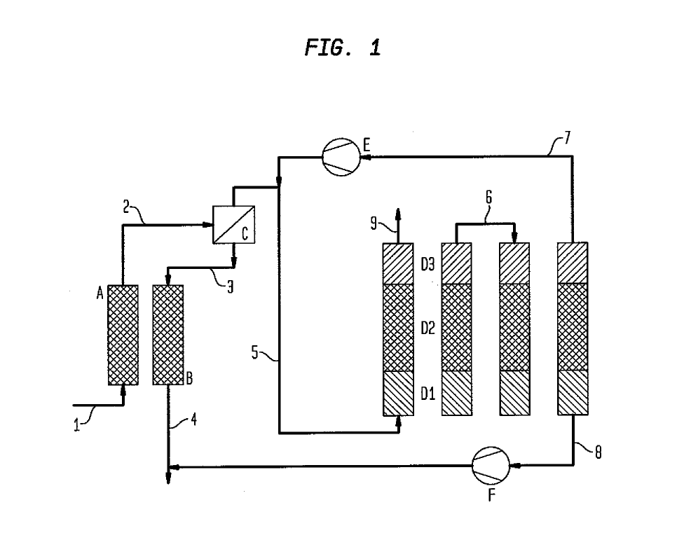

Turning to FIG. 1, natural gas is fed through line 1 to the PSA dryer bed A where water in the natural gas is removed. The dry natural gas is fed through line 2 to the membrane carbon dioxide removal unit C where much of the carbon dioxide present in the natural gas stream is removed. The permeate gas is fed through line 3 to the other PSA dryer bed B where it will regenerate bed B. The operation of beds A and B in the PSA system is such that while bed A is adsorbing water, bed B is being regenerated by the permeate gas from the membrane unit C. When their roles are reversed, bed B will adsorb water from the natural gas stream and bed A will be regenerated by the permeate gas. The regeneration gas stream will leave bed B through line 4 and can be used for power generation.

The natural gas stream will exit the membrane carbon dioxide removal unit C through line 5 and be fed to the VSA system D. Each of the four beds present in the VSA system has three layers, D1, D2 and D3. The four bed VSA system operates in a typical cycle with either one or two equalizations.

The following chart shows a four cycle VSA process with one equalization step.

Steps

| | | 1 | 2 | 3 | 4 |
|---|---|---|---|---|---|
| Adsorber | A | ADS | E1 PP | D P | E1 R |
| | B | E1 R | ADS | E1 PP | D P |
| | C | D P | E1 R | ADS | E1 PP |
| | D | E1 PP | D P | E1 R | ADS |

ADS = Adsorption
E = Equalization
PP = Prov. Purge
P = Purge
R = Repressurisation
D = Dump

The next chart shows a four cycle VSA process with two equalization steps.

| | | | | | | | | |
|---|---|---|---|---|---|---|---|---|
| A | E1↑ | PP | E2↑ | V | P | E2↓ | E1↓ | BF |

| | | | | | | | | |
|---|---|---|---|---|---|---|---|---|
| E1↓ | BF | A | E1↑ | PP | E2↑ | V | P | E2↓ |

| | | | | | | | | |
|---|---|---|---|---|---|---|---|---|
| V | P | E2↓ | E1↓ | BF | A | E1↑ | PP | E2↑ |

| | | | | | | | | |
|---|---|---|---|---|---|---|---|---|
| E1↑ | PP | E2↑ | V | P | E2↓ | E1↓ | BF | A |

The bottom layer D1 is for carbon dioxide polishing and can contain an adsorbent material such as 13× zeolite. The second layer, D2 is for bulk nitrogen removal and can comprise a titanosilicate/molecular gate sieve, such as ETS-4. The top layer D3 is for oxygen removal and employs a sieve material such as carbon molecular sieve. The natural gas stream now free of carbon dioxide, nitrogen and oxygen leaves the first VSA bed through line 9.

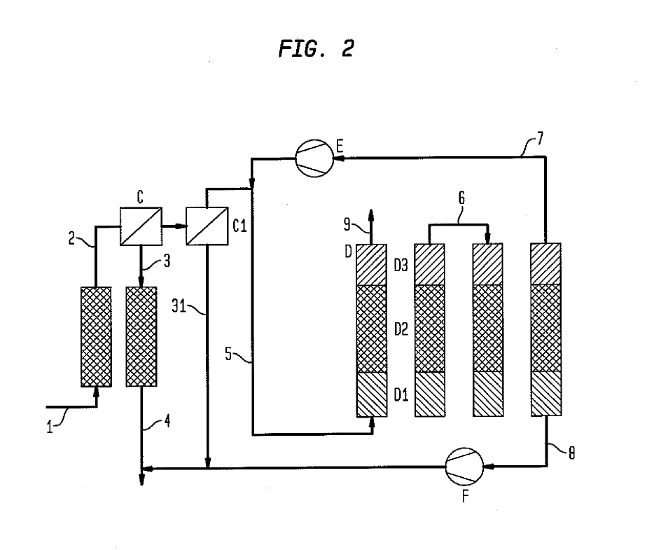

In FIG. 2, the same number designations are employed except for the additions of the second membrane unit. There line 31 connects the first membrane unit C to second membrane unit C1 and line 51 carries the permeate discharge to the combined waste line 8 for discharge and/or power generation purposes. When two sets of membrane units are used, the second unit will help reduce the amount of carbon dioxide in the natural gas stream further and may thus require less carbon dioxide removal material in the VSA system.

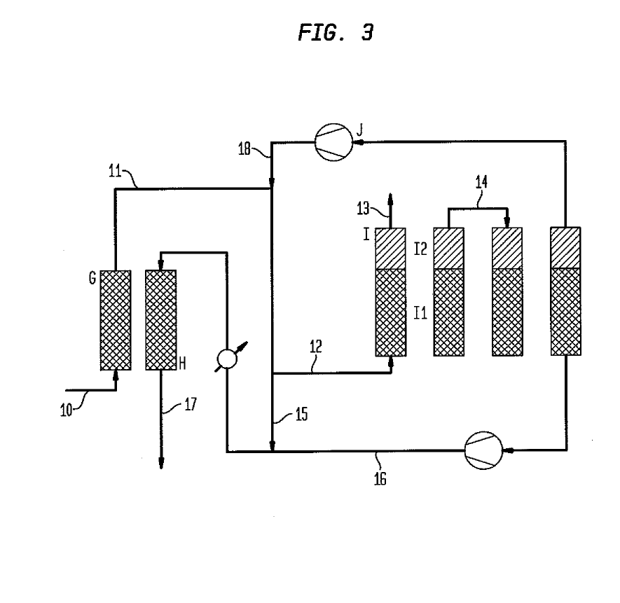

In FIG. 3, the carbon dioxide membrane units as discussed in FIGS. 1 and 2 are not present. The natural gas is fed through line 10 to a TSA system bed G where water is adsorbed from the natural gas. The dry natural gas is directed from the bed through line 11 to the VSA system I. In the first bed of the four beds designated, 11 contains a material for removing nitrogen and can comprise a titanosilicate/molecular gate sieve, such as ETS-4. The natural gas then enters the top layer of the bed 12 where a material for removing oxygen such as carbon molecular sieve is present. The natural gas free of oxygen and nitrogen will exit the bed through line 13.

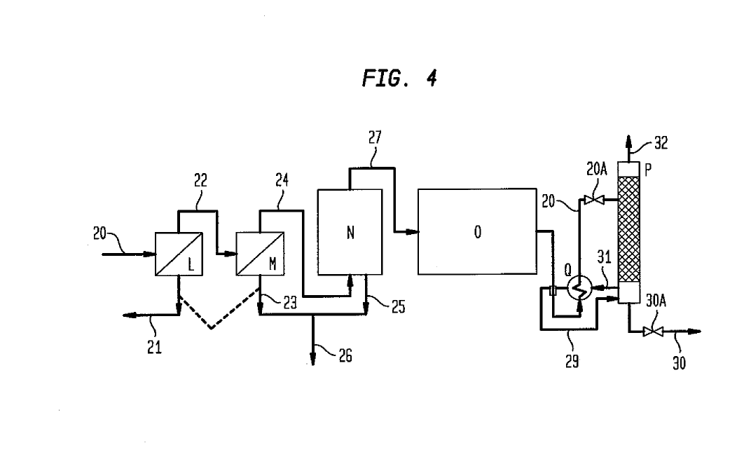

In FIG. 4, the oxygen rejection schematic for liquid natural gas production from natural gas feed streams is shown. A natural gas stream enters the membrane system first membrane L through line 20. The natural gas will pass through line 22 to second membrane unit M while the permeate carbon dioxide will exit through line 21 and be directed for a later use such as a regeneration gas. The natural gas with substantial amounts of carbon dioxide is directed from membrane unit M through line 24 to a multibed VSA system N. The permeate carbon dioxide and oxygen will exit the second membrane unit M through line 23 and will be joined with the tail gas from the VSA system N line 25 and combined as waste gas and exit the system through line 26. The multibed VSA can be similar in operation to the four bed, multilayer systems of FIGS. 1 and 2 where in this embodiment the beds contain two layers of material. The first layer is to polish carbon dioxide from the natural gas stream and the second layer is to remove nitrogen from the natural gas stream.

The natural gas stream will exit the VSA system N through line 27 and enter a liquefier where the natural gas becomes liquefied. This liquefied natural gas stream which is primarily natural gas with some oxygen leaves the liquefier through line 20 and enters an oxygen stripper column P. The stripper column P may be a packed or tray type of distillation column. Line 20 passes through heat exchanger Q and valve 20A. The oxygen that is rejected leaves the stripper column P through line 32 and the natural gas will exit in one instance through line 31 and through heat exchanger Q where it will be chilled further before reentry into the stripper column P through line 29. The liquefied natural gas is recovered through line 30 and valve 30A.

While this invention has been described with respect to particular embodiments thereof, it is apparent that numerous other forms and modifications of the invention will be obvious to those skilled in the art. The appending claims in this invention generally should be construed to cover all such obvious forms and modifications which are within the true spirit and scope of the present invention.

Having thus described the invention, what we claim is:

1. A method for the removal of contaminants from a natural gas stream comprising the steps:
a) feeding the natural gas stream containing contaminants to a dryer;
b) feeding the dry natural gas stream to a membrane module where carbon dioxide and oxygen are removed from the natural gas stream; and
c) feeding natural gas stream to a multibed, multilayer vacuum swing adsorption system wherein carbon dioxide, nitrogen and oxygen are removed from the natural gas stream.

2. The method as claimed in claim 1 wherein said dryer is selected from the group consisting of pressure swing adsorption and temperature swing adsorption units.

3. The method as claimed in claim 1 wherein said oxygen, nitrogen and carbon dioxide are present in said natural gas in amounts of 0 to 5 mole %, 5 to 15 mole % and 30 to 45 mole % respectively.

4. The method as claimed in claim 2 wherein said pressure swing adsorption and said temperature swing adsorption units contain beds of activated alumina.

5. The method as claimed in claim 1 wherein said membrane module comprises more than one membrane module.

6. The method as claimed in claim 1 wherein said membrane is a modified hollow fiber polyamide nitrogen membranes.

7. The method as claimed in claim 1 further comprising removing oxygen from said natural gas stream with said membrane module.

8. The method as claimed in claim 1 wherein said multibed, multilayer vacuum swing adsorption system comprises four beds.

9. The method as claimed in claim 8 wherein said four beds each comprise three layers.

10. The method as claimed in claim 9 wherein said three layers comprise a 13× molecular sieve, a titanosilicate sieve and a carbon molecular sieve respectively.

11. A method for the removal of contaminants from a natural gas stream comprising the steps:
a) feeding said natural gas stream containing contaminants to a dryer; and
b) feeding said dry natural gas to a multibed, multilayer vacuum swing adsorption system.

12. The method as claimed in claim 11 wherein said dryer is a temperature swing adsorption system.

13. The method as claimed in claim 12 wherein said temperature swing adsorption system comprises an activated alumina bed.

14. The method as claimed in claim 11 wherein said multibed, multilayer vacuum swing adsorption system comprises four beds.

15. The method as claimed in claim 14 wherein said four beds each comprise three layers.

16. The method as claimed in claim 15 wherein said three layers comprise a 13× molecular sieve, a titanosilicate sieve and a carbon molecular sieve respectively.

17. A method for rejecting oxygen from a natural gas stream comprising the steps:
a) feeding said natural gas stream to a membrane module;
b) feeding said natural gas stream to a multibed, multilayer vacuum swing adsorption system;
c) feeding said natural gas stream to a liquefier; and
d) feeding said natural gas stream to an oxygen stripper column.

18. The method as claimed in claim 17 wherein said membrane module removes carbon dioxide from said natural gas stream.

19. The method as claimed in claim 17 wherein said multibed, multilayer vacuum swing adsorption system removes carbon dioxide and nitrogen from said natural gas stream.

20. The method as claimed in claim 17 wherein natural gas is recovered from said oxygen stripper column.

21. The method as claimed in claim 17 wherein said membrane module comprises more than one membrane module.

22. The method as claimed in claim 17 wherein said membrane is a modified hollow fiber polyamide nitrogen membranes.

23. The method as claimed in claim 17 further comprising removing oxygen from said natural gas stream with said membrane module.

24. The method as claimed in claim 1 wherein said multibed, multilayer vacuum swing adsorption system comprises four beds.

25. The method as claimed in claim 24 wherein said four beds each comprises two layers.

26. The method as claimed in claim 25 wherein said two layers comprise a 13× molecular sieve and a titanosilicate sieve.

27. The method as claimed in claim 17 wherein said oxygen stripper column is selected from the group consisting of packed and tray type stripper column.
